(19) United States
(12) Patent Application Publication
(10) Pub. No.: US 2006/0263036 A1
(43) Pub. Date: Nov. 23, 2006

(54) Information recording apparatus and information recording/reproducing apparatus

(76) Inventor: Hiroyuki Marumori, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/261,712

(22) Filed: Oct. 31, 2005

(30) Foreign Application Priority Data
May 20, 2005 (JP) 2005-147487

(51) Int. Cl. H04N 5/91

(52) U.S. Cl. 386/46

(57) ABSTRACT

When the remaining capacity of a DVD disc of a DVD-HDD combo camera becomes small but the user still wants to continue shooting, the user should turn over the disc. To allow the user not to lose a shutter chance while turning over the disc, the recording medium is switched to the HDD while access is not made to the DVD and data is recorded on the HDD while the DVD is turned over. This enables all video data to be recorded even while the DVD is turned over. This configuration ensures an easy-to-use information recording/reproducing apparatus that allows the user not to lose a shutter chance even while the DVD is turned over.

### INCORPORATION BY REFERENCE

The present application claims priority from Japanese application JP2005-147487 filed on May 20, 2005, the content of which is hereby incorporated by reference into this application.

### BACKGROUND OF THE INVENTION

1. Field of the Invention

The present invention relates to an information recording apparatus and an information recording/reproducing apparatus using two recording media, for example, to an information recording apparatus and an information recording/reproducing apparatus having DVD and HDD drives.

2. Description of the Prior Art

The conventional problem is “facilitating the operation after save recording of data in a hard disc if a residual capacity of a DVD (digital video disk) lessened while the data is recorded in the DVD” (see abstract in US2004/0223727A1). The solution of the problem is a technology that “if it is detected that the residual capacity of a DVD is lessened while a program is recorded in the DVD, then save recording of the program in a hard disc is started, and the recording of the program in the DVD is stopped. If it is detected that the DVD is ejected and exchanged to a new DVD, the recording of the program in the new DVD is automatically started. While continuing the save recording of the program in the hard disc, the save-recorded program is time-shift reproduced from the beginning. The program reproduced from the hard disc is splice-recorded in the DVD” (US2004/0223727A1, Abstract).

### SUMMARY OF THE INVENTION

Today, disc media such as a DVD are used as a recording medium of a video camera. Because there is no worry about overwriting and because recorded audio and video data can be reproduced and retrieved easily, more and more discs are used as a recording medium instead of tapes. One of the problems with a DVD is that the capacity is defined by the standard. For example, an 8 cm DVD can include 1.4 G bytes on one side. This means that one DVD disc can include only about one hour of video/audio data at 3M bps. Actually, data is usually recorded at about 6M bps with consideration for image quality and therefore, in this case, one disc can record only 30 minutes of data. Recording data of higher image quality would further reduce the recording time.

One solution to this problem is that, with a mobile-use hard disk (hereinafter called an HDD) on a DVD camera, data is usually recorded on the HDD and only necessary data is recorded on a DVD. This method allows the user to mainly use the HDD for long-time recording and copy only desired data to the DVD. However, images recorded by a camera are stored as a library in many cases and, therefore, if images are recorded on the HDD, the user must copy them later to the DVD. Thus, considering the ease of use, it is better to record data directly on the DVD. The problem here is that, when recording on a DVD, the user must exchange discs depending on the shooting time as described above. For example, the user sometimes wants to continue shooting even when the remaining capacity of the disc is small. In this case, a disc exchange request, if issued from the user, generates a recording inhibition time during which the disc is ejected and checked. As a result, the user sometimes loses a shooting chance while exchanging discs.

Thus, to allow the user to not to lose a shooting chance, data is recorded on the HDD, another recording medium, while turning over the DVD. In that case, the user should stop accessing the DVD because data cannot be recorded on the DVD while recording data on the HDD.

The following describes how a camera including both DVD and HDD records data. A mobile product such as a camera must be designed to consume less power. One way to do so is to intermittently drive the drives. The intermittent driving method, which reduces power consumption by accessing the disc intensively during a specific period of time, will be described below with reference to FIG. 2A and FIG. 3A. FIG. 2A is a diagram showing the relation between the buffer accumulation amount and the time during the intermittent driving processing. The vertical axis indicates the buffer accumulation amount. The horizontal axis is a time axis. Periods 201-204 are periods of time during which data is accumulated in the buffer. Periods 205-208 are periods of time during which data accumulated in the buffer is written on the disc.

FIG. 3A is a diagram showing the flow of generated stream data. The numeral 301 indicates an AV stream generation unit that generates a program stream. The numeral 302 indicates a buffer in which a stream generated by the AV stream generation unit 301 is accumulated. The numeral 302 indicates a recording medium such as a DVD. The AV data generated by the AV stream generation unit 301 is once accumulated in the buffer 302 and, when the amount of accumulated data reaches a predetermine level, is written on the disc 320. The interval of time at which data is written on the disc is scores of seconds in actual time. In other words, the scores-of-seconds access time and the non-access time alternate. The periods 201-204 in FIG. 2A are non-access periods, while the periods 205-208 are access periods during which data is written on the disc. The non-access period is a period during which data is accumulated in the buffer 302. Normally, the size of the buffer 302 is usually determined so that the actual time of a stream is 20 seconds to 30 seconds.

The recording medium is switched from the DVD to the HDD by using the non-access time described above. That is, the DVD termination processing and the HDD recording preparation processing are performed during the scores of seconds, during which no access is made to the DVD, for recording data on the HDD smoothly and without interruption. In addition, after inserting the disc, the HDD termination processing and the DVD access preparation processing are performed during the next non-access period for restart the recording. After that, data is copied from the HDD to the DVD to record a continuous video in the DVD.

The present invention provides an apparatus that records a video to the HDD while the DVD is turned over to allow the user not to lose a shutter chance.

To implement the apparatus described above, the present invention provides an information recording apparatus using two or more recording media, comprising imaging means for imaging a video; and a drive control unit for controlling writing of video data, which is output from the imaging means, on a first recording medium and a second recording medium wherein, when the video data is recorded on the first recording medium and then the first recording medium is removed for exchange, the drive control unit records the video data on the second recording medium and, after the first recording medium is exchanged, records the video data on the exchanged first recording medium and automatically moves the video data, which is recorded on the second recording medium, to the exchanged first recording medium.

To implement the described above, the present invention provides an information recording/reproducing apparatus using two or more recording media, comprising a video/audio signal receiving circuit for receiving a video signal and an audio signal; an AV stream generation unit for multiplexing the video signal and the audio signal; a buffer memory for accumulating the multiplexed data; and a drive control unit for controlling writing of the data, which is accumulated in the buffer memory, on the first recording medium and the second recording medium wherein, in response to a request from a user, the drive control unit performs intermittent driving processing when data is written from the first recording medium to the second recording medium.

According to the present invention, the user who uses a camera including both DVD and HDD can continuously shoot images without interruption even when the disc capacity becomes insufficient and the disc must be turned over while recording on the DVD.

The present invention provides an easy-to-use information recording apparatus and information recording/reproducing apparatus.

Other objects, features and advantages of the invention will become apparent from the following description of the embodiments of the invention taken in conjunction with the accompanying drawings.

### BRIEF DESCRIPTION OF THE DRAWINGS

FIGS. 1A and 1B are diagrams showing the configuration of this system.

FIGS. 2A and 2B are diagrams showing the relation between a buffer accumulation amount and a time during intermittent driving processing.

FIGS. 3A, 3B, and 3C are diagrams showing the data flow of a generated stream.

FIG. 4 is a flowchart for the processing executed when a discs is turned over.

FIG. 5 is a flowchart showing the processing in a second embodiment.

FIGS. 6A and 6B are diagrams showing a navigation screen used in this system.

### DESCRIPTION OF THE EMBODIMENTS

Embodiments of the present invention will be described below with reference to the drawings.

### 1. First Embodiment

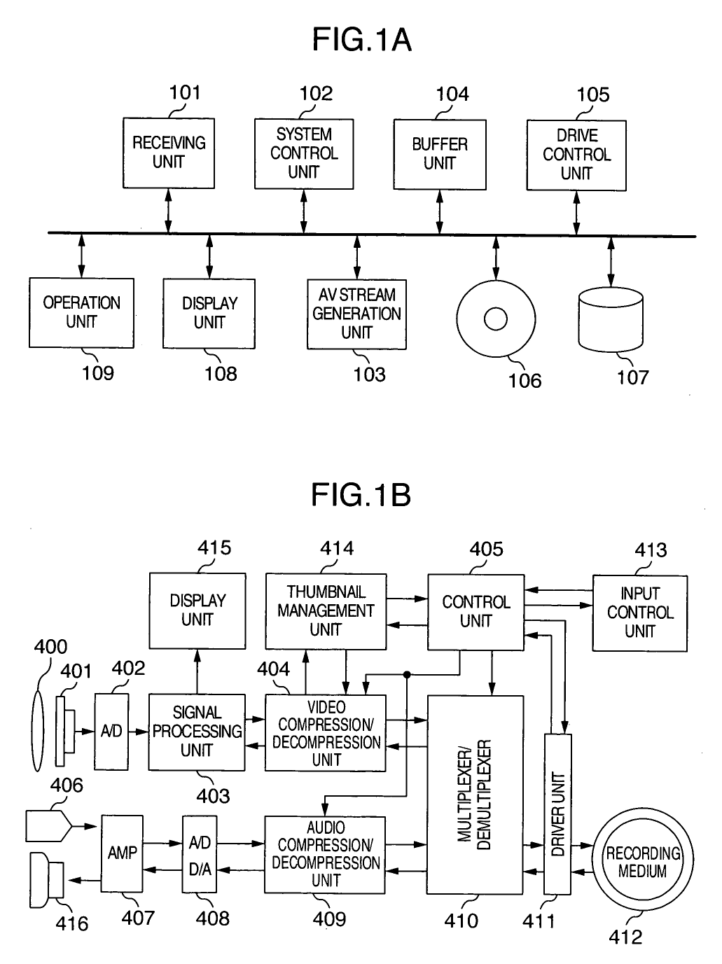

The following describes a first embodiment of the present invention with reference to FIG. 1 to FIG. 4. FIG. 1 is a diagram showing the configuration in which this embodiment is executed. In the description below, a DVD video camera in which an HDD is included is used as an example of a camera. The HDD may be built-in type or detachable. A semiconductor memory, if used instead of the HDD, could achieve the equivalent effect. In the description below, a built-in HDD is used. Any type of DVD (RAM, +RW, +R, or BD (Blu-Ray Disc)) may also be used. In this embodiment, a RAM disc is assumed.

The numeral 101 in FIG. 1A indicates a video/audio receiving unit such as a CCD or a microphone. The numeral 102 indicates a system control unit that controls the general operation of the camera. The numeral 103 indicates an AV stream generation unit that compresses a video and an audio received by the video/audio receiving unit 101 and multiplexes them into a program stream. The numeral 104 indicates a buffer memory where a program stream generated by the AV stream generation unit 103 is accumulated. The numeral 106 indicates a DVD, and the numeral 107 indicates an HDD. The numeral 105 indicates a control unit that controls access to the DVD 106 and the HDD 107. The numeral 108 indicates a display unit for displaying a video, and the numeral 109 indicates an operation unit including buttons used by the user to request the video camera to perform processing. Although not shown, the standard video camera functions are assumed to be included, such as a decompression block for reproducing a video, a speaker for outputting an audio, and a D/A converter.

FIG. 1B is a diagram showing, in more detail, the configuration shown in FIG. 1A. The numerals 400, 401, and 406 correspond to the video/audio receiving unit 101 given above such as the CCD or the microphone. A control unit 405, which corresponds to the system control unit 102, generally controls the camera. A multiplexer/demultiplexer 410, which corresponds to the AV stream generation unit 103 given above, multiplexes the video and audio data into a program stream. A driver unit 411 is a controller that has the buffer memory 104 given above in which a program stream generated by the AV stream generation unit 103 is accumulated. An input control unit 413, which corresponds to the control unit 105 given above, allows the user to access the DVD 106 and the HDD 107.

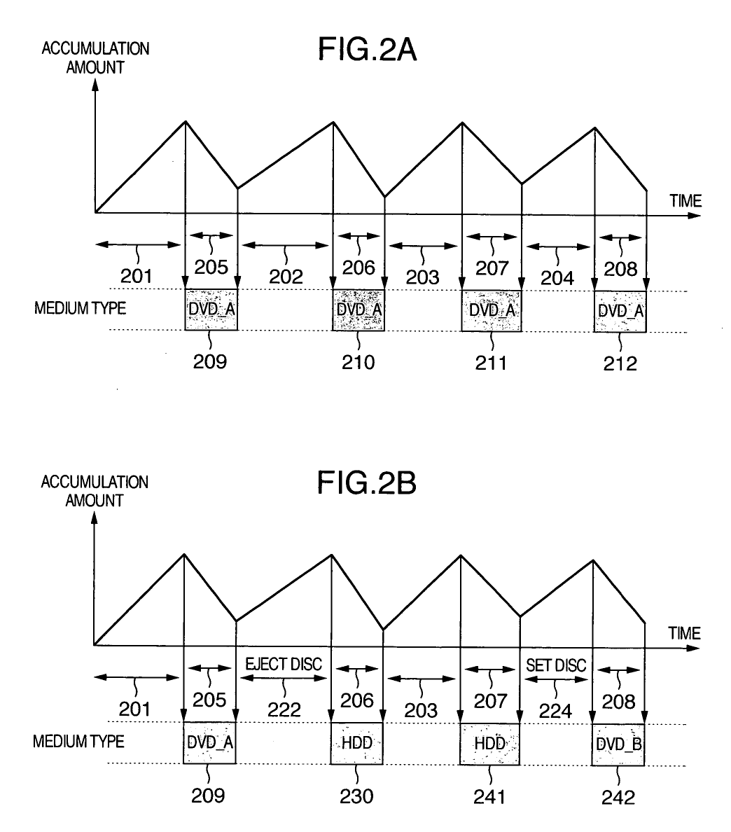

FIGS. 2A and 2B are diagrams showing the relation between the buffer accumulation amount and the time during the intermittent driving processing. FIG. 2A is a diagram showing the usual recording state, and FIG. 2B is a diagram showing the operation of the present invention. The vertical axis indicates the buffer accumulation amount. The horizontal axis is a time axis. The numerals 201-204 indicate the periods during which data is accumulated in the buffer. The numerals 205-208 indicate the period during which data accumulated in the buffer is written on a disc. The numerals 209-212, 230, 241, and 242 indicate the type of medium on which data is written. The numerals 209-212 represent the first side (side-A) of the DVD, the numerals 230 and 241 indicate the HDD, and the numeral 242 indicates the second side (side-B) of the DVD.

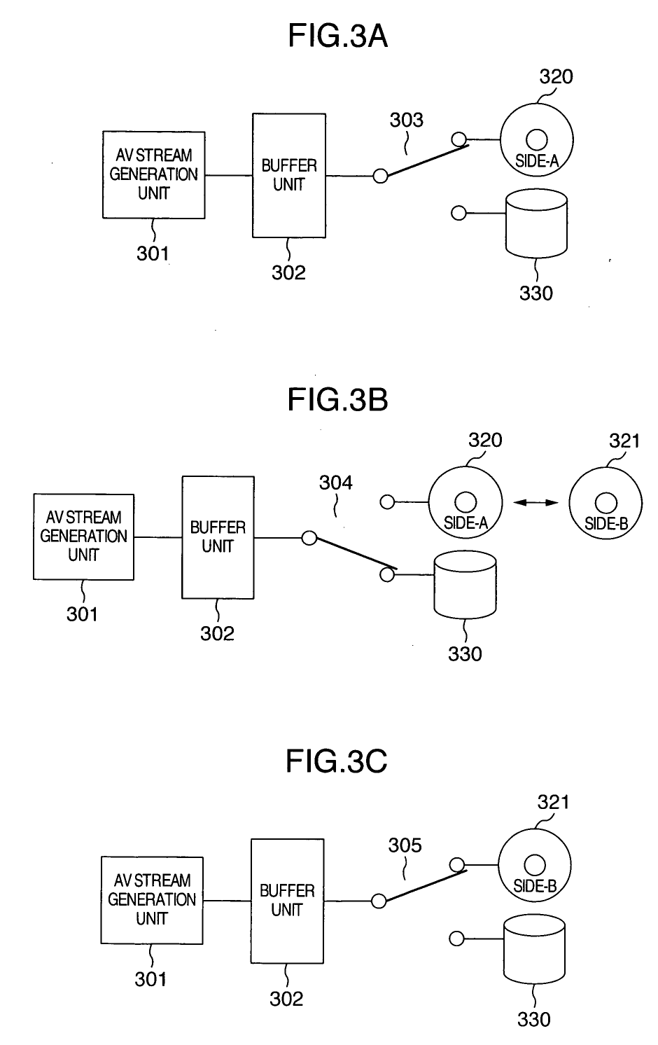

FIGS. 3A, 3B, and 3C are diagrams showing the data flow of a generated stream. FIG. 3A shows the state in which data is being recorded in the usual operation mode, FIG. 3B shows the state in which DVD disc is being turned over, and FIG. 3C shows the state in which the DVD disc has been turned over. The AV generation unit 301, which corresponds to the AV stream generation unit 103 in FIG. 1A, generates a program stream. The buffer 302, which corresponds to the buffer memory 104 in FIG. 1A, is a buffer in which the stream generated by the AV stream generation unit 301 is accumulated. The numerals 303-305 indicate to which medium, DVD or HDD, access is being made. The numerals 320, 321, and 330 indicate recording media. The numeral 320 represents the first side of the DVD, the numeral 321 represents the second side of the DVD, and the numeral 330 represents the HDD. The numeral 321, which represents the second side of the DVD in this example, may also be a DVD different from the DVD indicated by the numeral 320.

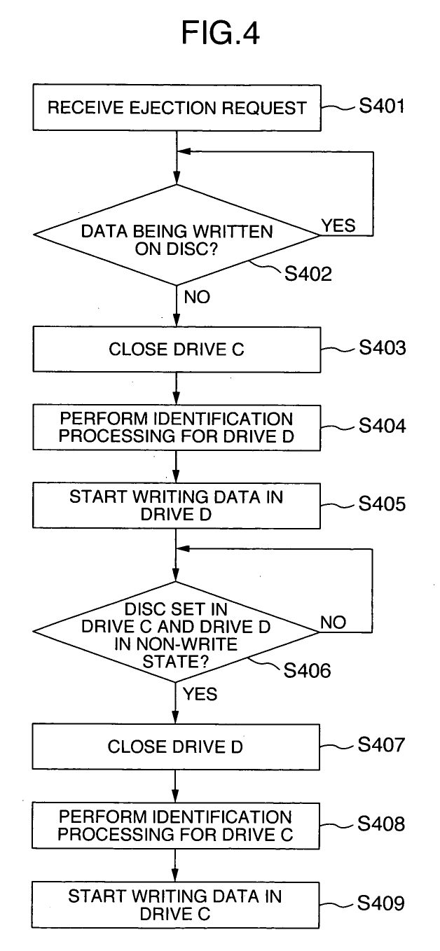

FIG. 4 shows the flow of the processing when a disc is turned over. In S401, a disc ejection request is issued. In S402, whether data is being written on the disc is checked. In S403, the termination processing for the DVD drive is performed. For convenience of the description, assume that the DVD is in drive C and the HDD is in drive D. The termination processing as used herein refers to the execution of a desired procedure for the file management information and the stream management information so that data can be recorded normally in the next operation. In S404, the identification processing for the HDD in drive D is performed. The identification processing as used herein refers to the processing necessary for starting the recording operation including the checking of the disk status. In S405, the recording in drive D is started. In S406, whether the disc is set in drive C and drive D is in non-write state is checked. In S407, the termination processing for drive D is performed. The termination processing as used herein refers to the execution of a desired procedure for the file management information and the stream management information so that data can be recorded normally in the next operation. In S408, the identification processing for the DVD in drive C is performed. The identification processing as used herein refers to the processing necessary for starting the recording operation including the checking of the disc status. In S409, the recording of data in drive C is started.

First, the following describes the usual recording processing.

When the user issues a recording instruction from the operation unit 109, the system control unit 102 starts receiving video and audio data from the receiving unit 101 and starts recording the signals. The AV stream generation unit 103 compresses the received video/audio signals into elementary streams. In addition, the elementary streams of audio and video signals are multiplexed into a program stream. For example, if the recording medium is a BD (Blu-ray Disc), the audio and video elementary streams are transformed into a transport stream. That is, a stream having a configuration conforming to the recording medium standard is generated. The streams generated in this step are accumulated in the buffer memory 104. Normally, data is managed in the buffer in an end-around sheme. The drive control unit 105 monitors the accumulation amount of the buffer 104 and, if a predetermined threshold is exceeded, sends data to the DVD 106 for writing thereon. Note that the disc must be identified before data is written on it. In this example, assume that the disc is already identified when the power was turned on. When the user issues a recording stop request via the operation unit 109, the system control unit 102 notifies the recording stop request to the drive control unit 105 to stop recording. At that time, it is confirmed that the file management information and the AV stream management information are consistent so that the next recording operation can be started smoothly.

When data is written from the buffer 104 to the DVD 106, the intermittent driving processing is performed as described above. As shown in FIG. 2A, data is accumulated in the buffer 104 during the period 201 and is written to the DVD when the time to write data reaches. Data is written on the DVD in the period 205. After this, the periods 202 and 206, the periods 203 and 207, and the period 204 and 208 are combined to repeat the processing. For convenience, the notation DVD_A is used to indicate that data is recorded on the first side of the DVD in periods 209-212.

The following describes this embodiment in detail.

Conventionally, data is recorded as described above. The problem is that, when the remaining capacity of the DVD becomes small, the user must turn over the disc for continued recording. Therefore, when the remaining capacity becomes small, the apparatus in this embodiment informs the user via the GUI about that status. In response, the user issues a disc ejection request via the operation unit 109. This is the processing in S401 in FIG. 4. In response to this request, the system control unit 102 checks if the apparatus is currently in the non-access state and if data is being written on the disc. This is the processing in S402. If this request is received in the period 205 in FIG. 2B, it is necessary to wait until the apparatus enters the period 222. When the apparatus enters the period 222, the preparation is started for the user to eject the DVD.

First, the termination processing for drive C is performed as shown in S403 so that the next operation will be executed normally. After this step, the user can eject the DVD. The processing performed up to this point corresponds the state shown in FIG. 3A. The AV data generated by the AV stream generation unit 301 is once accumulated in the buffer 302 and, when the amount of accumulated data reaches a predetermined level, is written to the disc 320. This state is represented by the numeral 303 in FIG. 3 to indicate that access is being made to the DVD. The termination processing for drive C is performed in this state. After that, the preparation for starting writing data on the HDD in drive D is performed. This is the processing shown in S404.

After the processing in S404 is terminated normally, the write operation in drive D is started in S405. This period is the period 206 in FIG. 2B. That is, data is recorded in drive D beginning with this period. During this period, the user ejects the disc and sets it again in the apparatus so that data is recorded on the second side (shows as DVD_B). Whether the disc is set is checked in S406 and so, once the DVD is set, the checking result of this step indicates that the DVD has been set. If the checking result indicates the period 207 in FIG. 2, it is necessary to wait until the apparatus enters the period 224. When the apparatus enters the period 224, the termination processing for drive D, in which data has been recorded up to that moment, is performed in S407. The processing from S404 to S407 corresponds to the state shown in FIG. 3B. The numeral 304 represents that access is being made to the HDD for writing data on the HDD.

While data is recorded on the HDD 330, the user ejects the DVD 320, turns it over, and sets it again as shown by a DVD 321. Once it is confirmed that the DVD is set, the termination processing for the HDD is performed. After that, the identification processing (preparation for starting data recording) for the DVD in drive C is performed in S408 and, after the preparation is finished, data is written on the DVD in drive C beginning in S409. Data is written on the second side of the DVD beginning in the period 208. The processing S408-S409 corresponds to the state shown in FIG. 3C. The numeral 305 represents that access is made to the DVD to record data on the second side of the DVD. After the preparation for recording data on the turned-over DVD 321 is finished, recording data on the DVD is restarted. Either the user may perform the processing steps S401-S409 or the apparatus may monitor the remaining capacity of the DVD and automatically move to the processing described above. To notify that the apparatus automatically performs the processing, the apparatus should display a message via the GUI.

As described above, the apparatus utilizes periods, during which a disc is not accessed, to allow the user to continue recording with no interruption in the video.

### 2. Second Embodiment

Next, a second embodiment will be described.

The second embodiment is similar to the first present invention except some additional functions.

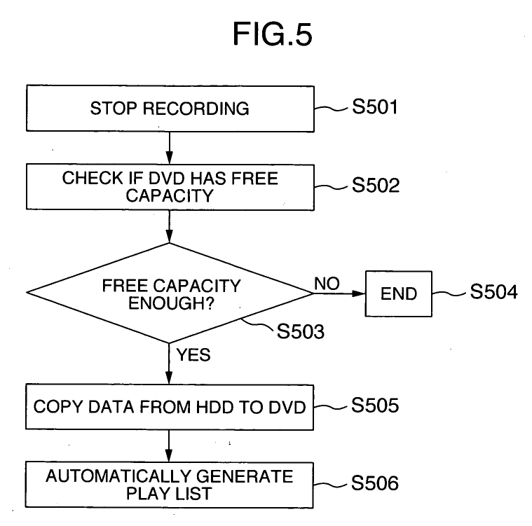

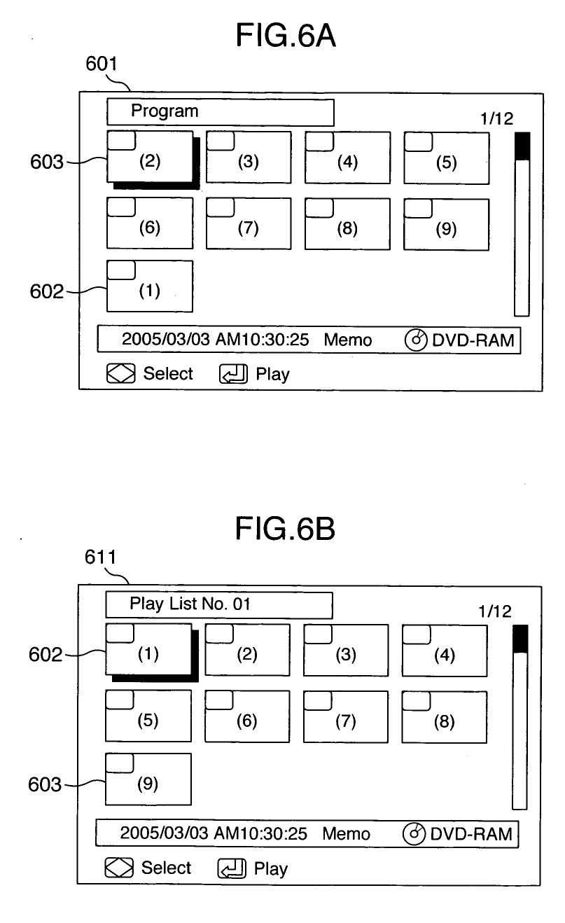

The following describes the second embodiment of the present invention with reference to FIG. 5 and FIG. 6.

FIG. 5 is a processing flowchart of the second embodiment. In S501, the recording stop processing is performed. This step indicates that, after the recording of data is restarted in the first embodiment, the user issues the recording stop instruction and the recording is stopped. In this stopped state, the video recorded while the DVD is turned over remains recorded on the HDD. This video must be copied to the DVD to produce a complete library. Therefore, the preparation for copying the data from the HDD to the DVD is performed. In S502, the remaining capacity of the DVD is checked. At this time, it is necessary to check if the DVD has a capacity large enough to store the data recorded on the HDD. If it is found in S503 that the DVD has not a capacity large enough, the processing is terminated as in S504. In that case, the disc must be exchanged for a disc that has enough capacity and the processing must be repeated beginning in S502. At the same time, a message should be issued to notify the user about the status via the GUI. If it is found in S503 that the DVD has enough capacity, the video data is copied from the HDD to the DVD. This is the processing in S505. After this processing, the DVD includes data that was lost when the DVD was turned over but the data on the DVD is still out of sequence.

The following describes this state with reference to FIGS. 6A and 6B. FIG. 6A shows a navigation screen displayed after the recording was stopped and then the missing video part was copied. The numeral 601 indicates the title bar. The numeral 602 indicates the thumbnail screen of the video data copied from the DVD. The numeral 603 indicates the thumbnail screen displayed immediately after the disc was turned over. The numeral 611 indicates the title bar where “Play List” is displayed.

When shooting with a camera, the thumbnail screen such as the one shown in the figure is created each time data is recorded. FIG. 6A shows that eight scenes ((2) to (9)) were shot after the disk was turned over and then scene (1), indicated by numeral 602, was copied from the HDD. That is, immediately after the copy operation, the copied data that is chronologically the first data is displayed as the last data on the navigation screen. To solve this problem, a play list including chronologically correct sequence data is created with the recorded original data unchanged. The play list is a function for managing only sequence management information as a separate file without changing the original data. FIG. 6B shows an example of a play list in which data is rearranged in the chronological sequence. Such a play list is generated automatically in S506. This is a function convenient to the user.

In this example, the operation generated by adding S501-S506 to the first embodiment is performed automatically. Instead of this, a GUI can also be added to allow the user to manually select whether to generate the processing S501-S506. The apparatus may also be configured so that the user can manually select whether to manually execute the processing S501-S506. For example, when the recording is stopped, a message is displayed to prompt the user to copy data. Such an option eliminates the need for the user, who does not want to copy data, to do redundant processing. However, it should be noted that one of the advantages of the automatic execution of the operation added by S501-S506 is that the user can transparently copy video data from the HDD to the DVD. On the other hand, another configuration is also possible where, if the battery is low (equal to or lower than a predetermined value) or if the AC power is not connected, the user can suppress the execution of S501-S506. This configuration makes more battery capacity available for shooting.

If the amount of data on the HDD is small and therefore the data can be copied from the HDD to the DVD quickly, it is also possible to copy data from the HDD to the DVD after turning over the DVD and before starting the recording. This operation eliminates the need for generating a play list and allows the chronologically correct data, such as the one shown in FIG. 6B, to be directly recorded.

The play list, if generated as described above, allows the video data on the HDD to be displayed in the chronologically correct sequence. It is also possible to record video data in the chronologically correct sequence by copying it to the HDD immediately after the DVD is turned over.

In the second embodiment, the data stored on the HDD is moved to the DVD at a time after the video data that is shot is recorded to DVD_B. However, because data is recorded on the DVD intermittently as shown in FIG. 2, the data may also be moved from the HDD to the DVD during the periods during which data is not recorded on the DVD. Such a period occurs between the periods during which data is recorded on the DVD. (The periods during which data is not recorded on the DVD correspond to the numerals 202, 203, and 204 in FIG. 2A. Note that, though data is recorded on the first side of the DVD in FIG. 2A, data is recorded on the second side of the DVD in this example. In this example, to distinguish between the first side and the second side, the periods corresponding to the numerals 202, 203, and 204 are indicated by the numerals 202′, 203′, and 204′). In this case, another buffer may also be prepared for storing data moved from the HDD to the DVD separately from the buffer for storing recorded data that is shot. Alternatively, one buffer may be divided into two, one for storing recorded data that is shot and the other for storing data moved from the HDD to the DVD. By moving data as described above from the HDD to the DVD, for example, in the period 202′, no extra time is required to move the data from the HDD to the DVD after data that is shot is recorded on the DVD.

It should be further understood by those skilled in the art that although the foregoing description has been made on embodiments of the invention, the invention is not limited thereto and various changes and modifications may be made without departing from the spirit of the invention and the scope of the appended claims.

1. An information recording apparatus using two or more recording media, comprising:
imaging means for imaging a video; and
a drive control unit for controlling writing of video data, which is output from said imaging means, on a first recording medium and a second recording medium,
wherein, when the video data is recorded on the first recording medium and then the first recording medium is removed for exchange, said drive control unit records the video data on said second recording medium and, after said first recording medium is exchanged, records the video data on the exchanged first recording medium and automatically moves the video data which has been recorded on said second recording medium to the exchanged first recording medium.

2. An information recording/reproducing apparatus using two or more recording media, comprising:
a video/audio signal receiving circuit for receiving a video signal and an audio signal;
an AV (Audio Visual) stream generation unit for multiplexing the video signal and the audio signal;
a buffer memory for accumulating the multiplexed data; and
a drive control unit for controlling writing of the data, which is accumulated in said buffer memory, on said first recording medium and said second recording medium,
wherein, in response to a request from a user, said drive control unit performs intermittent driving processing when a data-write destination is switched from said first recording medium to said second recording medium.

3. The information recording/reproducing apparatus according to claim 2,
wherein said first recording medium is an optical disc and said second recording medium is a magnetic disk or a semiconductor memory.

4. The information recording/reproducing apparatus according to claim 2, further comprising a display unit capable of displaying data copied to said first recording medium and data recorded on said first recording medium in chronological sequence when said drive control unit copies data which has been recorded on said second recording medium to said first recording medium.

5. The information recording/reproducing apparatus according to claim 2,
wherein said drive control unit copies data which has been recorded on said second recording medium to said first recording medium according to a capacity of said first recording medium.

6. The information recording/reproducing apparatus according to claim 2, wherein said second recording medium is a removable magnetic disk or a semiconductor memory.

7. The information recording/reproducing apparatus according to claim 2,
wherein, when the switching data-write destination from said first recording medium to said second recording medium in response to a request from a user, said drive control unit starts writing data on said second recording medium after writing data on said first recording medium is finished.

8. The information recording/reproducing apparatus according to claim 2,
wherein said first recording medium is smaller than said second recording medium in capacity.
